(19) United States
(12) Patent Application Publication
(10) Pub. No.: US 2023/0147949 A1
(43) Pub. Date: May 11, 2023

(54) METHODS OF MAKING SELF-FOAMING NON-DAIRY CREAMER COMPOSITIONS

(71) Applicant: WhiteWave Services, Inc., Denver, CO (US)

(72) Inventors: Pulari Krishnankutty Nair, Denver, CO (US); Luke Michael Chavez, Broomfield, CO (US)

(21) Appl. No.: 18/053,166

(22) Filed: Nov. 7, 2022

Related U.S. Application Data
(60) Provisional application No. 63/263,777, filed on Nov. 9, 2021.

(51) Int. Cl. A23C 11/08

(52) U.S. Cl. CPC A23C 11/08

(57) ABSTRACT

The invention describes foamable non-dairy creamers and frothing compositions that do not require the use of steam or a compressed gas to afford the foamed composition useful in a hot beverage such as coffee.

### CROSS REFERENCE TO RELATED APPLICATIONS

This application claims priority to provisional application No. 63/263,777, filed Nov. 9, 2021 and titled METHODS OF MAKING SELF-FOAMING NON-DAIRY CREAMER COMPOSITIONS, the entire content of which is incorporated herein by reference.

### FIELD OF THE INVENTION

The invention relates generally to foamable non-dairy creamers and frothing compositions that do not require the use of steam or a compressed gas to afford the foamed composition useful in a hot beverage such as coffee.

### BACKGROUND OF THE INVENTION

The preparation of a latte, cappuccino, mocha, or macchiato can be time consuming, a bit awkward and/or unsafe and generally requires either an expensive apparatus to brew the hot beverage and/or dairy product or the need to visit a specialty beverage shop to have a barista prepare the drink of choice. Going to a specialty shop also increases the cost of purchasing such a beverage versus the preparation at home.

Generally, the dairy or non-dairy (for example, soy or almond milk) composition is heated with steam to form a foam and/or a heated dairy composition. The generation of steam to froth the dairy product can be problematic with back splashing of the dairy composition which could scald or burn the operator. Additionally, touching the heated container that retains the hot dairy composition can also lead to scalding or burning of the operator. In certain instances, the operator may overheat the dairy composition so that it is not useful in the beverage and requires that it be discarded and a new portion of dairy composition be subjected to heating again, thus possibly causing waste of the dairy composition.

If the operator does prepare the heated dairy composition in the convenience of a home or office, a fairly expensive apparatus is required to generate the steam to froth the dairy composition. Locating such an apparatus can be problematic as it may not fit well in a home kitchen or office setting due to cost, size, and/or complexity (e.g., necessarily having water lines connected to the apparatus or providing containers of water to be used in the generation of steam).

For example, the optimum effect is discernible in milk from the mid stratum where small bubbles predominate. Too much heat will destroy the structure of the milk sugars leading to their caramelization and the resultant over-heated milk will mask the flavor and presence of the majority of natural beverage, e.g., coffee essences. The milk will effectively undergo a phase separation, lose frothiness and, apart from scalding the mouth of the consumer, it will cause the beverage, e.g., coffee to develop scorched off-flavors and possible curdling due to the denaturing of the proteins.

If the consumer decides to visit a specialty shop, added costs to prepare the beverage of choice are incurred versus the preparation by the consumer at home or in the office.

Therefore, a need exists for the preparation of a product that overcomes one or more of the current disadvantages noted above.

### BRIEF SUMMARY OF THE INVENTION

The present invention surprisingly provides foamable non-dairy compositions that can be used by the consumer without the need for the use of steam or a compressed gas to achieve a frothed beverage, such as a latte.

In one aspect, the foamable non-dairy compositions described herein can be foamed by shaking the container containing a liquid foamable non-dairy composition in a container which can then be added to a beverage, such as hot coffee. In another aspect, the foamable non-dairy compositions do not need to be shaken and can be used as a traditional creamer.

In one embodiment, the foamable non-dairy compositions include at least one of micellar casein or a caseinate or a mixture thereof; a buffering agent, such as, one or more of dipotassium phosphate, tripotassium-dipotassium phosphate or trisodium-disodium phosphate; a mixture of mono and diglycerides of edible fatty acids; polysorbate 80 (Polyoxyethylene (20) sorbitan monooleate); a gum; a vegetable oil; water; optionally, a salt; optionally, a citrate or a phosphate; optionally, a stearoyl lactylate; optionally, a sweetener; and optionally, a flavoring, wherein the total amount of constituents equals 100 weight percent.

In another embodiment, the foamable non-dairy compositions include a milk protein concentrate (MPC); a buffering agent, such as one or more of dipotassium phosphate, tripotassium-dipotassium phosphate or trisodium-disodium phosphate; an alpha-cyclodextrin; a vegetable oil; optionally, a sweetener; optionally, a citrate or a phosphate; optionally, a flavoring agent; optionally a salt; and water to equal 100 percent by weight.

Advantages of the current embodiments include avoiding the use of steam to prepare a frothed hot dairy or non-dairy (for example, soy or almond milk) or a compressed gas to effectuate frothing/foaming in a hot beverage.

Additionally, the current embodiments help to reduce the cost to a consumer for enjoyment of a hot beverage, such as coffee, without having to purchase a specialty steam producing apparatus to produce a steamed dairy or non-dairy product or the need to go to a coffee shop and purchase the item.

Further, the consumer avoids the potential for splashing the hot frothed/foamed dairy or non-dairy product onto themselves which can ruin clothing or even cause injury (scalding) to the consumer.

Use of compressed gas to foam/froth a dairy or non-dairy product increases cost to the creaming composition due to the need for a container that can hold pressure. Such items then need to be discarded and either recycled or placed into a landfill which is not environmentally friendly.

The products and non-dairy compositions described herein provide advantages over lattes. The non-dairy compositions described herein can be refrigerated or can remain at room temperature. Therefore, a consumer can go to the refrigerator, grasp the container, shake the container and the contents therein and pour the non-dairy composition into a hot beverage. Thus, the non-dairy compositions described herein allows the beverage to be consumed immediately after preparation due to the chilled or room temperature non-dairy creamer, rather than have to wait for a period of time to let it cool.

Another advantage of the non-dairy compositions described herein provide flavoring. The non-dairy compositions can sweeten, flavor, and can cream both the body of the coffee and the resultant foam layer.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 depicts the particle size distribution (PSD) of the emulsion of Example 1.

FIG. 2 provides stability results for Example 1 versus a commercial product (International Delight French Vanilla coffee creamer by Danone North America).

FIG. 3 depicts the particle size distribution (PSD) of the emulsion of Example 2.

FIG. 4 provides the particle size distribution (PSD) of the emulsion of Example 3.

### DETAILED DESCRIPTION

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

The term “brewed” refers to a process whereby one or more chemical constituents of a beverage's flavor base (e.g., seeds, herbs, tea leaves, coffee beans, and the like, and combinations thereof) are dissolved in a liquid (e.g., water) through a process of steeping, stewing, soaking, marinating, immersion or the like. In some embodiments, the liquid is hot (e.g., at or near its boiling point) at some point during its contact with the beverage's flavor base.

The terms “foam”, “foamable”, “froth”, “frothed” and the like refer to a composition that is not a homogeneous liquid but an object formed by trapping pockets of gas in a liquid or solid. In most foams, the volume of gas is large, with thin films of liquid or solid separating the regions of gas. Foams are examples of dispersed media. In general, gas is present, so it divides into gas bubbles of different sizes (that is, the material is polydisperse); separated by liquid regions that may form films, thinner and thinner when the liquid phase drains out of the system films.

In some embodiments, a beverage in accordance with the present teachings is tea-based. This would include a beverage derived from a brewing process in which one or more soluble compounds of tea leaves are extracted by hot water and/or steam. Representative tea-based beverages in accordance with the present teachings can prepared from a variety of types of teas including but are not limited to white tea, yellow tea, green tea, oolong, tea, black tea, post-fermented tea, herbal tea (i.e., leaves, flowers, fruit, herbs or other plant material which, technically, are not teas inasmuch as they are devoid of Camellia sinensis), and the like, and combinations thereof. Representative types of tea-based beverages in accordance with the present teachings include but are not limited to bata bata, bubble tea (foam tea), cha manao, cha yen (Thai tea), chai (masala chai), Hong Kong milk tea (pantyhose milk tea), iri ko, kashmiri chai, kombucha, matcha, obuku cha, sweet tea, tapioca pearl tea (boba tea), tea punch, the tank (Malaysian pulled tea), Tibetan yak butter tea, and the like, and combinations thereof.

In some embodiments, a beverage in accordance with the present teachings is coffee-based. A coffee-based beverage is derived from a brewing process in which one or more soluble compounds of coffee beans are extracted from ground coffee beans by hot water and/or steam. The coffee-based beverage can be produced from a specific type of coffee bean (e.g., Kona bean) or from a blend of different types of beans grown in different geographical areas. Representative bean types include but are not limited to Columbian, Ethiopian, Sumatra, Jamaica Blue Mountain, Panama, and the like, and combinations thereof.

Further, the compositions described herein can be delivered to beverages and food stuffs such as, for example and not limited to, hot cocoa, cold coffee, cold tea, milkshakes, frappes, ice cream, cookies, cakes, sodas, soups, etc.

Thus the term “beverage” as referred to herein, denotes tea based or coffee based products and other products described herein that can be treated with the compositions described herein before consumption by an individual.

The term “latte” refers to a coffee drink made with espresso and steamed milk, typically 1 part espresso and 3 parts milk Typically the milk is steamed through a special high pressure steam pipe on the espresso machine. This serves two functions. To warm up the milk and to create a foam on the top.

The term “cappuccino” refers to a coffee drink that is traditionally prepared with espresso, hot milk, and steamed milk foam. Generally, a cappuccino is prepared as 1:1:1 ratio of espresso, steamed milk, and milk foam. Typically the milk is steamed through a special high pressure steam pipe on the espresso machine. This serves two functions. To warm up the milk and to create a stiff foam on the top.

The term “mocha” refers to a coffee drink based on espresso and hot milk, but with added chocolate, typically in the form of sweet cocoa powder, although many varieties use chocolate syrup.

The term “macchiato” is a cappuccino, but with the steamed milk component missing. That is, it is espresso and frothed milk foam only.

It should be understood that how the non-dairy composition is delivered by the consumer to the beverage will dictate whether the ultimate beverage would be considered, for example, a latte, cappuccino, mocha, macchiato, or a hybrid thereof (and similarly for the equivalents in tea). The present embodiments provide that the foamed non-dairy composition is poured into/onto the surface of the beverage. Some amount of the foamed non-dairy composition may disperse into the beverage. Thus, after delivery, the foamed non-dairy composition can form a foam layer with a portion that remains intimately dispersed throughout the liquid beverage.

The present embodiments pertain to the delivery of a foamable non-dairy composition to a beverage such that a portion of the foamable non-dairy composition is mixed and is retained within the liquid beverage and a portion forms an upper layer on the surface of the liquid beverage and remains as a foamed layer for a period of time during which the consumer drinks the beverage.

In the case where the foamable non-dairy composition is not subjected to shaking prior to delivery to the beverage, the non-dairy composition will disperse throughout the beverage like any typical creamer.

Typically, the foamable non-dairy compositions described herein should be shaken just prior to use. Shake times can vary but can be from a second to several seconds and up to 10 seconds or more with 4 to 5 seconds being the optimal shake time.

The foamable non-dairy compositions are conveniently contained in ten (10) ml single serving containers such as those known in the art, often referred to as “creamers”, as single use delivery items.

Alternatively, the foamable non-dairy compositions can be conveniently contained in 16 ounce, 24 ounce, 32 ounce, 48 ounce or any other sized containers. As the foamable non-dairy composition is consumed, the remaining contents continue to exhibit foamable properties until the last of the composition is depleted.

In the present application a “non-dairy composition” refers to a composition that is not substantially based on animal milk components. As a foamable non-dairy creamer composition, it is understood a non-dairy composition is substantially free-of milk fat or milk fat substitutes obtained from milk proteins, such as some microparticulated whey proteins. Herein non-dairy compositions can comprise some milk non-fat ingredients, such as proteins obtained from milk, for example caseinates or Milk Protein Concentrates (MPCs), in particular, in amounts of lower than 10.00% by weight, more particularly lower than 6.00% by weight, even more particularly lower than 5.00% by weight, in particular lower than 4.00% by weight, and more particularly lower than 3.00% by weight.

Embodiments disclosed herein provide numerous technical advantages. According to one embodiment, the non-dairy composition can cream the beverage while also generating a head of foam on the surface of the beverage. The beverage can be creamed without requiring subsequent stirring. Additionally, the foam may have a strong structure that may be maintained when exposed to a hot beverage. The non-dairy composition can reduce problems associated with known beverage additives such as weak creaming, weak foaming, off-flavor, potential to cause splashing, requirements for significant headspace above the coffee in the cup, excessive cooling, and/or unsanitary packaging. According to one embodiment, the non-dairy composition can be used to prepare a coffee or tea based beverage in the home, school, office, hospital, or any place where a small container can be easily stored. For example, the non-dairy composition and delivery system can be portable, easy to use, safe, and/or low cost.

When the foamable non-dairy composition(s) are added to coffee, as an example, it provides a latte experience to the consumer. Typical non-dairy creamers on the market do not exhibit foamable properties such as those described herein. Surprisingly, the current embodiments provide a similar whitening, flavor, mouthfeel and organoleptic properties to those of non-dairy creamers in the marketplace but with the foaming/frothing aspect that is currently lacking from those in the marketplace. The current embodiments described herein have similar fat, total solids and nutritional properties of existing non-dairy creamers present in the marketplace.

Compositions

The compositions described herein are typically foamable non-dairy compositions. The foamable non-dairy compositions are liquid compositions, comprising at least one of micellar casein or a caseinate or a mixture thereof; a buffering agent, such as, one or more of dipotassium phosphate, tripotassium-dipotassium phosphate or trisodium-disodium phosphate; a mixture of mono and diglycerides of edible fatty acids; polysorbate 80 (Polyoxyethylene (20) sorbitan monooleate); a gum; a vegetable oil; water; optionally, a salt; optionally, a citrate or a phosphate; optionally, a stearoyl lactylate; optionally, a sweetener; and optionally, a flavoring, wherein the total amount of constituents equals 100 weight percent.

The term “micellar casein” refers to the by-product of cheese-making and is the least-processed version of casein. It is a family of phosphoproteins, featuring all five caseins: alpha, beta, gamma, delta, and kappa. It's made by separating the casein phosphoproteins from whey, fat, and lactose in milk. Micellar casein concentrate (MCC) is isolated from milk through filtration.

Suitable ranges of micellar casein are from about 0 percent by weight (if not present in a composition) to about 2 percent by weight, for example, from about 0.1 to about 2 percent by weight, from about 0.2 to about 2 percent by weight, from about 0.5 to about 1.5 percent by weight, from about 0.75 to about 1.25 percent by weight, from about 1.5 to about 2 percent by weight and all weight percentages and ranges in between from about 0.0001 to about 2 percent by weight.

A “caseinate” refers to a metal casein that are highly dispersible in water and is typically manufactured by adding acid to warm skim milk. As the pH of the skim milk lowers to the range of 4.2 to 4.6, the casein precipitates out of the skim milk as a curd. The casein curd is then washed repeatedly with acidified fresh water to “purify” the casein (wash away unwanted, occluded milk solids such as fat and lactose). Because the casein curd is kept at an acid pH, the milk minerals are leached out of the protein. The result is a relatively pure protein curd (96% protein on a dry basis).

Casein curd, however, is not very useful in food products. Acid casein (as the curd is known) is insoluble in water, behaving much like sand. In order to make the casein curd more useful in food products, the acid casein curd is reacted with a strong alkali to result in an almost neutral protein product termed a caseinate. The type of alkali used to neutralize the acid casein curd will determine what type of caseinate is produced. For example, reacting acid casein curd with sodium hydroxide (to a pH of about 6.8) results in the formation of sodium caseinate. Reacting acid casein curd with calcium oxide or calcium hydroxide (to pH 6.8 to 7.6) results in the formation of calcium caseinate. Sodium caseinate is the most water soluble form of caseinate. Sodium caseinate typically forms high viscosity water dispersions. Calcium caseinate forms a low viscosity, opaque, off white dispersion in water. Calcium caseinate is usually the least water soluble of the caseinates and tends to sediment out of suspension within hours of being mixed into water. Whereas sodium caseinate will exhibit a smooth mouthfeel when dispersed in water, calcium caseinate will exhibit a slightly gritty or grainy mouthfeel. There are also sodium calcium caseinates, calcium sodium caseinates, and even calcium ammonium caseinates. The levels of each mineral are determined by the ratios of alkali used in the caseinate manufacture. The higher the sodium content, the higher the viscosity and water solubility. The higher the calcium content, the lower the water viscosity and solubility. Potassium caseinate possesses properties similar to sodium caseinate

Suitable caseinates include, for example, sodium caseinate, potassium caseinate and calcium caseinate.

Suitable ranges of a caseinate are from about 0 percent by weight (if not present in a composition) to about 2 percent by weight, for example, from about 0.1 to about 2 percent by weight, from about 0.2 to about 2 percent by weight, from about 0.5 to about 2 percent by weight, from about 1 to about 2 percent by weight, from about 1.5 to about 1.75 percent by weight and all weight percentages and ranges in between from about 0.0001 to about 2 percent by weight.

Dipotassium phosphate refers to K₂HPO₄ and is also known as dipotassium hydrogen orthophosphate or potassium phosphate dibasic. Dipotassium phosphate (50%) (potassium phosphate, dibasic) is available from FBC Industries, Inc.

“Monoglyceride” refers to a type of glyceride that is made up of glycerol and one fatty acid chain. Typically the fatty acid chain is an edible fatty acid. A suitable monoglyceride is glyceryl monostearate or glyceryl monopalmitate.

“Diglyceride” refers to a type of glyceride that is made up of glycerol and two fatty acid chains. Typically the fatty acid chain is an edible fatty acid. A suitable diglyceride is glyceryl distearate or glyceryl dipalmitate.

Some other examples of emulsifiers include glycerin fatty acid esters, acetic acid or lactic acid or citric acid or succinic acid esters of mono and diglycerides, diacetyl tartaric acid esters of mono and diglycerides, polyglycerol esters of fatty acids, sorbitan esters of fatty acids, propylene glycerol esters of fatty acids, etc.

Suitable ranges of emulsifiers are from about 0.001 percent by weight to about 2 percent by weight, for example, from about 0.01 to about 2 percent by weight, from about 0.1 to about 1.5 percent by weight, from about 0.2 to about 1 percent by weight, from about 0.5 to about 1 percent by weight, from about 0.5 to about 0.8 percent by weight and all weight percentages and ranges in between from about 0.001 to about 2 percent by weight.

“Polysorbate 80” is an emulsifier and refers to compounds derived from polyethoxylated sorbitan and oleic acid. The chemical name for polysorbate 80 is polyoxyethylene (2) sorbitan monooleate. The structure of polysorbate 80 is shown below:

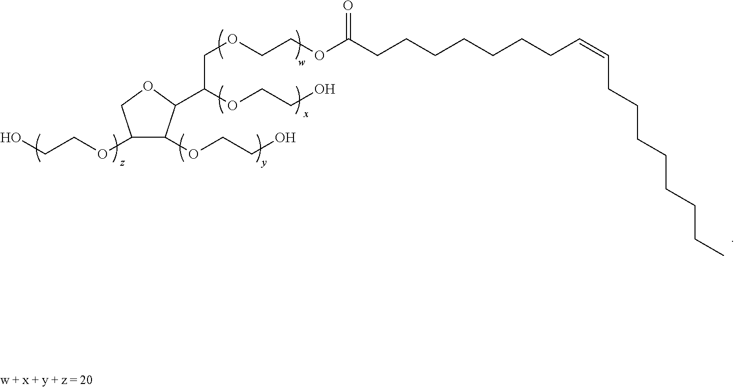

Suitable ranges of for the polysorbate 80 are from about 0.001 percent by weight to about 2 percent by weight, for example, from about 0.01 to about 2 percent by weight, from about 0.1 to about 1.5 percent by weight, from about 0.2 to about 1 percent by weight, from about 0.5 to about 1 percent by weight, from about 0.5 to about 0.8 percent by weight and all weight percentages and ranges in between from about 0.001 to about 2 percent by weight.

The term “gum” (also referred to as hydrocolloid) refers to Cellulose Gum, for example microcrystalline cellulose (MCC), cellulose gel (carboxymethylcelluose), Agar-agar, Carrageenan, Gellan Gum, Guar Gum, Konjac, Hydroxypropyl cellulose, Methylcellulose and Hydroxypropyl cellulose, Xanthan Gum, Gum Arabic, locust bean gum, Tara gum, Starch, Pectin, Gelatin, Propylene Glycol Alginate, seaweed flour, or combinations thereof.

Carrageenans are a family of natural linear sulfated polysaccharides that are extracted from red edible seaweeds. Carrageenans contain 15-40% ester-sulfate content, which makes them anionic polysaccharides. They can be mainly categorized into three different classes based on their sulfate content. Kappa-carrageenan has one sulfate group per disaccharide, iota-carrageenan has two, and lambda-carrageenan has three.

Acacia gums are hydrocolloids known by one skilled in the art, and are commercially available. They are also referred to as arabic gum. Acacia gum is a natural, soluble food fiber. It is a macromolecule with high molar mass (typically with a weight-average molecular weight between 4.105 and 2.106 g/mol). Its intrinsic viscosity is typically less than 0.2 dl/g (as measured for example according to Al-Assaf et al, Food Hydrocolloids, 2005, 19, 647-667; Flindt et al, Food Hydrocolloids, 2005, 19, 687-701). Acacia Gum is an acacia exudate, purified using a physical process well known to those skilled in the art, having the steps of grinding, dissolving in water, filtering, centrifuging, microfiltration, then spray drying or granulation. There are two types of Acacia Gum: Acacia seyal and Acacia Senegal. Their structures are slightly different. They can however be distinguished by a very different rotating power and by their proportion of simple sugars (46% arabinose in Acacia seyal and 24% in Acacia Senegal).

Suitable ranges of gums are from about 0.001 percent by weight to about 2 percent by weight, for example, from about 0.01 to about 2 percent by weight, from about 0.1 to about 1.5 percent by weight, from about 0.2 to about 1 percent by weight, from about 0.5 to about 1 percent by weight, from about 0.5 to about 0.8 percent by weight and all weight percentages and ranges in between from about 0.001 to about 2 percent by weight.

The term “vegetable oil” refers to oils from various plants and/or their seeds or fruit. Examples of vegetable oils include coconut oil, canola oil, soybean oil, sunflower oil, safflower oil, palm oil, palm kernel oil, pongamia oil, olive oil, avocado oil, high oleic fractions of sunflower oil, soyabean oil, canola oil, safflower oil, and various mixtures thereof.

Suitable ranges of the oil(s) used herein are from about 2 percent by weight to about 15 percent by weight, for example, from about 2 to about 12 percent by weight, from about 4 to about 10 percent by weight, from about 5 to about 9 percent by weight, from about 7 to about 9 percent by weight, from about 7.5 to about 8.5 percent by weight and all weight percentages and ranges in between from about 2 to about 15 percent by weight.

Examples of salts include sodium chloride, for example sea salt. Salt, sodium chloride, can also be included in the composition and one exemplary product is MORTON® CULINOX® Food Grade salt having a purity of greater than or equal to 99.95 weight percent.

Suitable ranges of salts are from about 0 percent by weight (if not present in a composition) to about 2 percent by weight, for example, from about 0.1 to about 2 percent by weight, from about 0.2 to about 1.8 percent by weight, from about 0.5 to about 1.5 percent by weight, from about 0.8 to about 1.2 percent by weight, from about 0.01 to about 1.8 percent by weight and all weight percentages and ranges in between from about 0.001 to about 2 percent by weight.

Water can be a purified water, a spring water, a filtered water, reverse osmosis water (RO water) or other water sources as long as it does not contain harmful bacteria or pathogens.

The term “citrate” refers to citric acid and various metal salts thereof, such as trisodium citrate, also referred to as sodium citrate but can also refer to any of the three salts of citric acid. Potassium salts of citric acid are also within the scope of the embodiments.

Suitable ranges of citrates are from about 0 percent by weight (if not present in a composition) to about 3 percent by weight, for example, from about 0.001 to about 3 percent by weight, from about 0.01 to about 2 percent by weight, from about 0.1 to about 1 percent by weight, from about 0.5 to about 0.9 percent by weight, from about 0.0001 to about 0.1 percent by weight and all weight percentages and ranges in between from about 0.001 to about 3 percent by weight.

The term “phosphate” refers to dipotassium salts or disodium salts of phosphate, tripotassim or trisodium salts of phosphate.

Suitable ranges of phosphates are from about 0 percent by weight (if not present in a composition) to about 3 percent by weight, for example, from about 0.1 to about 3 percent by weight, from about 0.2 to about 2.5 percent by weight, from about 0.5 to about 2 percent by weight, from about 1 to about 2 percent by weight, from about 1.5 to about 1.8 percent by weight and all weight percentages and ranges in between from about 0.0001 to about 3 percent by weight.

The term “stearoyl lactylate” (often abbreviated to as “SSL”) is currently manufactured by the esterification of stearic acid with lactic acid and partially neutralized with either food-grade soda ash (sodium carbonate) or caustic soda (concentrated sodium hydroxide). Commercial grade SSL is a mixture of sodium salts of stearoyl lactylic acids and minor proportions of other sodium salts of related acids. The HLB for SSL is 10-12. SSL is slightly hygroscopic, soluble in ethanol and in hot oil or fat, and dispersible in warm water. These properties are the reason that SSL is an excellent emulsifier for fat-in-water emulsions and can also function as a humectant. Suitable stearoyl lactylates include calcium stearoyl lactylate, sodium stearoyl lactylate, or combinations thereof.

Suitable ranges of lactylates are from about 0 percent by weight (if not present in a composition) to about 1 percent by weight, for example, from about 0.0001 to about 1 percent by weight, from about 0.001 to about 1 percent by weight, from about 0.01 to about 1 percent by weight, from about 0.1 to about 1 percent by weight, from about 0.1 to about 0.5 percent by weight and all weight percentages and ranges in between from about 0.0001 to about 1 percent by weight.

Sweeteners can sweeten the taste of the foamable non-dairy compositions described herein. Examples of sweeteners include sugar agents and sweeteners different from sugar agents, for example high intensity sweeteners or non-nutritive sweeteners. Examples include, monosaccharides, disaccharides, and polysaccharides including sugars and sugar alcohols, such as sucrose, glucose, fructose, dextrose, maltose, lactose, high fructose corn syrup, corn syrup solids, invert sugar, agave, coconut sugar, honey, maple syrup, and sorbitol, xitlitol, stevia extracts or fermentive equivalents, such as steviol glycosides, including compounds for example, Rebaudioside A, Rebaudioside B, Rebaudioside C, Rebaudioside D, Rebaudioside M, Stevioside, Rebaudioside F, Dulcoside A, Rubusoside and Steviolbioside, aspartame, acesulfame K (also known as Ace-K), sucralose or combinations thereof.

Suitable ranges of sweeteners are from about 0 percent by weight (if not present in a composition) to about 40 percent by weight, for example, from about 0.1 to about 35 percent by weight, from about 1 to about 30 percent by weight, from about 5 to about 25 percent by weight, from about 10 to about 20 percent by weight, from about 15 to about 18 percent by weight and all weight percentages and ranges in between from about 0.0001 to about 40 percent by weight.

In some embodiments, flavor can distinguish the taste of the composition. Any suitable flavor can be used, such as vanilla, French vanilla, Madagascar vanilla, hazelnut, amaretto, Irish crème, cinnamon, butter pecan, chocolate, caramel, or any other natural or artificial flavors or combinations of flavors.

Suitable ranges of flavoring agent(s) are from about 0 percent by weight (if not present in a composition) to about 4 percent by weight, for example, from about 0.1 to about 3.5 percent by weight, from about 1 to about 3 percent by weight, from about 0.5 to about 2.5 percent by weight, from about 1 to about 2 percent by weight, from about 1.5 to about 1.8 percent by weight and all weight percentages and ranges in between from about 0.0001 to about 4 percent by weight.

In some embodiments, water can be used to dilute the composition, for example, to ensure the composition has a proper flavor intensity and viscosity when it is delivered from the package.

In some embodiments, the compositions can include antioxidants to prevent lipid oxidation during shelf life. Examples of such antioxidants include BHA, BHT, propyl gallate, rosemary extract and tocopherols.

In another embodiment, the foamable non-dairy compositions include a milk protein concentrate (MPC); a buffering agent, such as, one or more of dipotassium phosphate, tripotassium-dipotassium phosphate or trisodium-disodium phosphate; alpha-cyclodextrin; a vegetable oil; optionally, a sweetener; optionally, a citrate or a phosphate; optionally, a flavoring agent; optionally a salt; and water to equal 100 percent by weight.

The term “alpha-cyclodextrin” refers to a hexasaccharide derived from glucose. All cyclodextrins are white and water soluble. A depiction of alpha cyclodextrin is shown below:

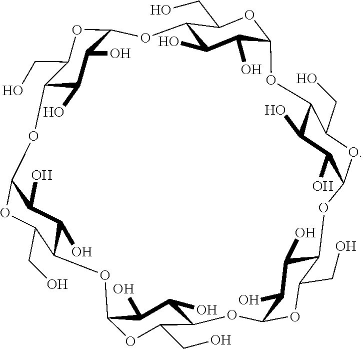 [SMILES: OCC1O[C@@H]2O[C@@H]3C(CO)O[C@H](O[C@@H]4C(CO)O[C@H](O[C@@H]5C(CO)O[C@H](O[C@@H]6C(CO)O[C@H](O[C@@H]7C(CO)O[C@H](O[C@H]1[C@H](O)[C@H]2O)[C@H](O)[C@H]7O)[C@H](O)[C@H]6O)[C@H](O)[C@H]5O)[C@H](O)[C@H]4O)[C@H](O)[C@H]3O]

Suitable ranges of cyclodextrins are from about 0 percent by weight (if not present in a composition) to about 3 percent by weight, for example, from about 0.001 to about 3 percent by weight, from about 0.01 to about 3 percent by weight, from about 0.1 to about 3 percent by weight, from about 1 to about 2 percent by weight, from about 1.5 to about 1.8 percent by weight and all weight percentages and ranges in between from about 0.0001 to about 3 percent by weight.

Suitable ranges of milk protein concentrate are from about 0 percent by weight (if not present in a composition) to about 8 percent by weight, for example, from about 0.1 to about 8 percent by weight, from about 0.2 to about 7 percent by weight, from about 0.5 to about 6 percent by weight, from about 1 to about 5 percent by weight, from about 2 to about 4 percent by weight and all weight percentages and ranges in between from about 0.0001 to about 8 percent by weight.

Milk protein concentrates (MPCs) are known in the art and are marketed as such. They comprise milk proteins (casein and whey) typically in a weight ratio similar to that in milk (about 80 wt % casein to 20 wt % whey), a limited amount of fat, and a limited amount of lactose, and some minerals. The protein content of MPCs is typically of higher than 50% by weight, more particularly higher than 60% and even more particularly higher than 70%. MPCs are different from milk powders such as Skim Milk Powder (SMP) in that significant amounts of lactose is removed. For example lactose in MPCs is typically lower than 20% by weight, for example, it is lower than 15%, on a dry basis, while lactose milk powders such as SMPs is typically of higher than 30% by weight on a dry basis. MPCs are different from whey concentrates or isolates, or casein concentrates or isolates in casein/whey ratios, whey concentrates or isolates having a ratio whey/casein much higher than the one in milk and casein concentrates or isolates having a ratio casein/whey much higher than the one in milk. Examples of MPCs that can be used in the compositions described herein include IdaPlus 1085 from Idaho Milk Products. It is a concentrate manufactured from pasteurized cow's milk using ultrafiltration and processed using low temperature skim milk powder production parameters. The MPC can have a fat content of from 1.5 to 3%, moisture of from 4 to 5.5%, protein 70% as a minimum total weight percent and a pH of from 6 to 7.

The compositions disclosed herein are emulsions, such as oil in water emulsions. The emulsions are stable at refrigerator temperatures or an ambient temperatures.

The particle size profile of the creamer emulsions was characterized using a laser diffraction particle size analyzer. For all measurements, a refractive index of 1.333 was used for the aqueous phase and 1.45 for the oil (palm oil) phase. The results of the particle size measurements are reported as volume weighted mean diameters D [4,3] and were based on an analysis of the measured angular light scattering pattern using Mie theory. The particle size distribution of these creamers shows a unimodal distribution throughout shelf life. More than 90% of the particles fall below a 1 μm with volume weighted mean ([D [4,3]) of under 1 μm.

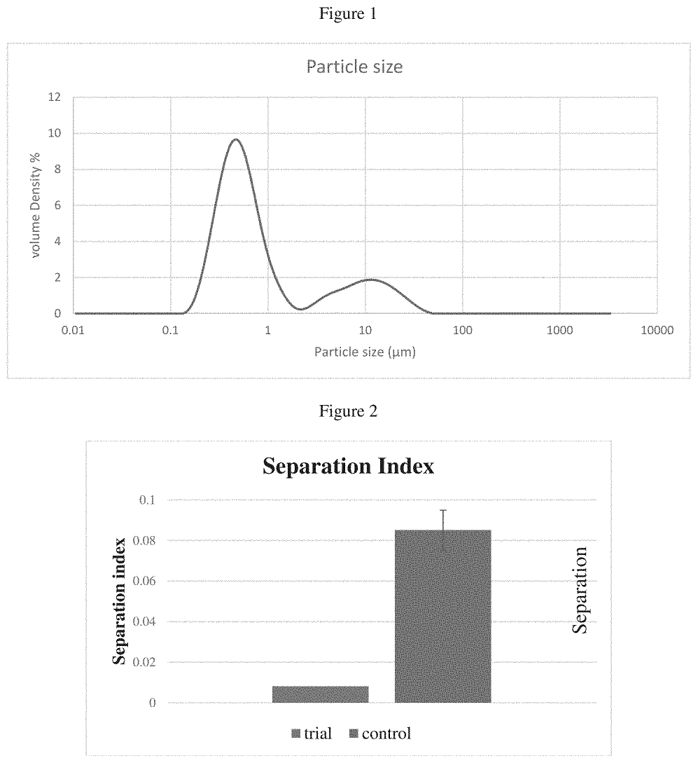

Particle size distribution, based on FIGS. 1, 3 and 4 range from about 0.128 μm to about 3.12 μm for unimodal distributions and from about 0.128 μm to about 48.61 μm for bimodal distributions. For example particle size distribution includes from about 0.136 μm to about 2.27 μm for a unimodal particle size distribution and from about 0.128 μm to about 7.64 μm for a bimodal particle size distribution.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The following paragraphs enumerated consecutively from 1 through 52 provide for various aspects of the present invention. In one embodiment, in a first paragraph (1), the present invention provides a composition comprising:

at least one of micellar casein or a caseinate or a mixture thereof;

one or more of dipotassium phosphate, tripotassium-dipotassium phosphate or trisodium-disodium phosphate;

a mixture of mono and diglycerides of edible fatty acids;

polysorbate 80 (Polyoxyethylene (20) sorbitan monooleate);

a gum;

a vegetable oil;

water;

optionally, a salt;

optionally, a citrate or a phosphate;

optionally, a stearoyl lactylate;

optionally, a sweetener; and

optionally, a flavoring, wherein the total amount of constituents equals 100 weight percent.

2. The composition according to paragraph 1, wherein the caseinate is sodium caseinate or calcium caseinate.

3. The composition according to either paragraph 1 or 2, wherein the caseinate is present in an amount of about 0 percent to about 2 percent by weight of the total composition.

4. The composition according to either paragraph 1 or 2, wherein the micellar casein is present in an amount of about 0 percent to about 2 percent by weight of the total composition.

5. The composition according to any of paragraphs 1 through 4, wherein the one or more of dipotassium phosphate, tripotassium-dipotassium phosphate or trisodium-disodium phosphate is present in an amount of about 0.1 percent to about 2 percent by weight of the total composition.

6. The composition according to any of paragraphs 1 through 5, wherein the mixture of mono and diglycerides of edible fatty acids are glyceryl monostearate and glyceryl distearate.

7. The composition according to any of paragraphs 1 through 6, wherein the mixture of mono and diglycerides of edible fatty acids are present in an amount of about 0.001 percent to about 2 percent by weight of the total composition.

8. The composition according to any of paragraphs 1 through 7, wherein the polyoxyethylene (20) sorbitan monooleate is present in an amount of about 0.001 percent to about 2 percent by weight of the total composition.

9. The composition according to any of paragraphs 1 through 8, wherein the range of glyceryl monostearate to glycerol distearate is from about 60 percent by weight to about 80 percent by weight.

10. The composition according to any of paragraphs 1 through 9, wherein the ratio of polyoxyethylene (20) sorbitan is about 10 to about 20 percent by weight to the total weight of the mono and diglycerides.

11. The composition according to any of paragraphs 1 through 10, wherein the gum comprises carrageenan, gellan gum or a combination of gums.

12. The composition according to any of paragraphs 1 through 11, wherein the gum is present in an amount of about 0.001 percent to about 2 percent by weight of the total composition.

13. The composition according to any of paragraphs 1 through 12, wherein the vegetable oil comprises palm oil.

14. The composition according to any of paragraphs 1 through 13, wherein the vegetable oil is present in an amount of about 5 to about 15 percent by weight of the total composition.

15. The composition according to any of paragraphs 1 through 14, wherein the optional salt is sodium chloride.

16. The composition according to any of paragraphs 1 through 15, wherein the optional salt is present in an amount of about 0 to about 2 percent by weight of the total composition.

17. The composition according to any of paragraphs 1 through 16, wherein the optional citrate or phosphate comprises a sodium or a potassium salt thereof.

18. The composition according to any of paragraphs 1 through 17, wherein the optional citrate or phosphate or salts thereof is present in an amount of about 0.001 to about 3 percent by weight of the total composition.

19. The composition according to any of paragraphs 1 through 18, wherein the optional stearoyl lactylate comprises sodium stearoyl lactylate.

20. The composition according to any of paragraphs 1 through 19, wherein the optional stearoyl lactylate is present in an amount of about 0.0001 to about 1 percent by weight of the total composition.

21. The composition according to any of paragraphs 1 through 20, wherein the optional sweetener comprises sucrose, xylitol, sucralose, stevia, high fructose corn syrup or mixtures thereof.

22. The composition according to any of paragraphs 1 through 21, wherein the optional sweetener is present in an amount of about 0 to about 35 percent by weight of the total composition.

23. The composition according to any of paragraphs 1 through 22, wherein the optional flavoring comprises a French vanilla.

24. The composition according to any of paragraphs 1 through 23, wherein the optional flavoring is present in an amount of about 0 to about 2 percent by weight of the total composition.

25. The composition according to any of paragraphs 1 through 24, wherein the composition is shaken for about 5 second, the composition provides a foamed non-dairy composition.

26. The composition according to any of paragraphs 1 through 25, wherein the composition, when shaken, provides a foamed composition with bubbles.

27. The composition according to paragraph 26, wherein the foamed composition retains its foam characteristics for at least 5 minutes.

28. The composition according to any of paragraphs 1 through 24, when not shaken, provides a non-dairy creamer.

29. The composition according to any of paragraphs 1 through 27, wherein a compressed gas is not used to prepare the foam characteristics.

30. The composition according to any of paragraphs 1 through 27, wherein steam is not used to prepare the foam characteristics.

31. A composition comprising:

a milk protein concentrate (MPC);

one or more of dipotassium phosphate, tripotassium-dipotassium phosphate or trisodium-disodium phosphate;

alpha-cyclodextrin;

a vegetable oil;

optionally, a sweetener;

optionally, a citrate or a phosphate;

optionally, a flavoring agent;

optionally a salt; and

water to equal 100 percent by weight.

32. The composition according to paragraph 31, wherein the milk protein concentrate is present in an amount of about 0.1 to about 8 percent by weight of the total composition.

33. The composition according to either paragraphs 31 or 32, wherein the one or more of dipotassium phosphate, tripotassium-dipotassium phosphate or trisodium-disodium phosphate is present in an amount of about 0.001 to about 3 percent by weight of the total composition.

34. The composition according to any of paragraph 31 through 33, wherein the alpha-cyclodextrin is present in an amount of about 0.001 to about 3 percent by weight of the total composition.

35. The composition according to any of paragraph 31 through 34, wherein the vegetable oil comprises palm oil.

36. The composition according to any of paragraph 31 through 35, wherein the vegetable oil is present in an amount of about 2 to about 10 percent by weight of the total composition.

37. The composition according to any of paragraphs 31 through 26, wherein the optional sweetener comprises sucrose, xylitol, sucralose, stevia, high fructose corn syrup or mixtures thereof.

38. The composition according to any of paragraphs 31 through 37, wherein the optional sweetener is present in an amount of about 0 to about 40 percent by weight of the total composition.

39. The composition according to any of paragraphs 31 through 38, wherein the optional citrate or phosphate comprises a sodium or a potassium salt thereof.

40. The composition according to any of paragraphs 31 through 39, wherein the optional citrate or phosphate or salts thereof is present in an amount of about 0 to about 3 percent by weight of the total composition.

41. The composition according to any of paragraphs 31 through 40, wherein the optional flavoring comprises a French vanilla.

42. The composition according to any of paragraphs 31 through 41, wherein the optional flavoring is present in an amount of about 0 to about 4 percent by weight of the total composition.

43. The composition according to any of paragraphs 31 through 42, wherein the optional salt is sodium chloride.

44. The composition according to any of paragraphs 31 through 43, wherein the optional salt is present in an amount of about 0 to about 1 percent by weight of the total composition.

45. The composition according to any of paragraphs 31 through 44, wherein the composition is shaken for about 5 second, the composition provides a foamed non-dairy composition.

46. The composition according to any of paragraphs 31 through 45, wherein the composition, when shaken, provides a foamed composition with bubbles.

47. The composition according to paragraph 46, wherein the foamed composition retains its foam characteristics for at least 5 minutes.

48. The composition according to any of paragraphs 31 through 44, when not shaken, provides a non-dairy creamer.

49. The composition according to any of paragraphs 31 through 44, wherein a compressed gas is not used to prepare the foam characteristics.

50. The composition according to any of paragraphs 31 through 44, wherein steam is not used to prepare the foam characteristics.

51. The composition according to any of paragraphs 1 through 50, wherein the composition is an emulsion.

52. The composition according to any of paragraphs 1 through 51, wherein the composition is a non-dairy composition.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

| Ingredient | % |
|---|---|
| Water | To make up to 100 |
| Trisodium Citrate | 0.120 |
| Micellar Casein (Micellar casein 48450 | 0.500 |
| from Leprino Foods) or sodium caseinate | |
| Dipotassium Phosphate | 0.400 |
| Mono and diglycerides | 0.8 |
| Polysorbate 80 | 0.25 |
| Salt (sodium chloride) | 0.021 |
| Sodium Stearoyl Lactylate | 0.070 |
| sucrose | 31.590 |
| Carrageenan | 0.085 |
| FRENCH VANILLA Flavor | 0.210 |
| Palm Oil | 8.300 |
| Total | 100.000 |

To prepare the composition of Example 1, the following steps were utilized:

a) heated water, with a temperature of at least 160° F. (155° F. to 165° F.) was combined with the mono glyceride and diglycerides (BFP 75 K from Caravan) with agitation followed by the addition of sugar, trisodium citrate and a stabilizer (carrageenan) to form a first mixture;

b) the first mixture was combined with an oil such as palm oil with mixing to form a second mixture;

c) the second mixture was combined with a caseinate, or micellar casein (Micellar casein 48450 from Leprino Foods) and at least one emulsifier (sodium stearoyl lactylate) and stirred well to form a third mixture;

d) the third mixture was combined with at least one buffering agent (Dipotassium Phosphate), salt and polysorbate 80 with mixing to form a fourth mixture;

e) optionally, the fourth mixture was combined with a flavoring agent such as French vanilla flavoring, with mixing to form a fifth mixture;

f) the fourth or fifth mixture was then combined with the remaining water (held at approximately 160° F.) with mixing to form a sixth mixture;

g) the sixth mixture was then subjected to high shear agitation or blending for about 5 minutes followed by a homogenization step at about 125° F. to about 145° F. to form a seventh mixture, which is then cooled to a temperature of 45° F. or less prior to the next step;

h) the seventh mixture was subjected to a UHT pasteurization at a temperature of at least 288° F. (284° F. to about 295° F.) for a few seconds step to form an eighth mixture; and

i) the eighth mixture was subjected to a second homogenization step at approximately 170° F. to about 180° F. to provide the foamable non-dairy composition of Example 1 which is cooled to approximately 45° F. or less prior to transfer to a sterile environment and packaged into suitable containers.

The product (either prepared with a caseinate or micellar casein), when shaken and poured in hot coffee at normal usage rates (60 ml creamer in 8 ounces of coffee), resulted in a foam height of 5 cm immediately after addition to the coffee. The foams are closely packed with velvety texture. Further, the foam is stable for >5 minutes over the surface of hot coffee.

FIG. 1 provides the particle size for the formulation with micellar casein or the caseinate in Example 1. FIG. 1 shows a bimodal distribution but the trial had significantly higher viscosity (0.06154 Pa s) than the control commercial creamer; International Delight French vanilla (0.02257 Pa s). This high viscosity of the continuous phase prevented any gravitational separation or creaming of oil droplets in the emulsion. FIG. 2 substantiates this stability information.

FIG. 2 provides stability information for Example 1.

Table 1 provides particle size characterization for Example 1 using a Lumisizer from LUM GmbH. The LUMiSizer instantaneously measures the extinction (space- and time-resolved) of the transmitted light across the entire length of a sample Space- and Time-resolved Extinction Profiles (STEP Technology). It is a technology that allows analysis of an entire sample instantaneously from top to bottom. The samples were centrifuged for an hour at refrigerated temp (4° C.) and separation was continuously monitored using a light scattering source.

TABLE 1

| | | | | | Specific |
|---|---|---|---|---|---|
| | Dx (10) | Dx (50) | Dx (90) | D [4,3] | Surface Area |
| Sample Name | (μm) | (μm) | (μm) | (μm) | (m²/kg) |
| Example 1 | 0.285 | 0.579 | 11.1 | 3.13 | 10730 |

### Example 2

| Ingredient | % |
|---|---|
| Water | 59.890 |
| Milk protein concentrate (MPC) (IdaPlus | 4.000 |
| 1085 from Idaho Milk Products) | |
| trisodium citrate | 0.120 |
| Disodium Phosphate Liquid 50% | 0.400 |
| Alpha cyclodextrin | 1.000 |
| Sugar | 31.590 |
| Palm Oil | 3.000 |
| Total | 100.000 |

To prepare the composition of Example 2, the following steps were utilized:

j) heated water at about 150° F. (145° F. to about 155° F.) was combined with a sodium citrate with mixing, followed by the addition of the sugar agent (sugar) and at least one stabilizer (trisodium citrate) to form a first mixture;

k) the first mixture was combined with oil (palm oil) with mixing to form a second mixture;

l) the second mixture was combined with a milk protein concentrate and alpha-cyclodextrin to form a third mixture;

m) the third mixture was combined with a buffering agent (Disodium Phosphate Liquid 50%) with mixing to form a fourth mixture;

n) optionally, the fourth mixture can be combined with a flavoring agent (not utilized in this example), with mixing to form a fifth mixture;

o) the fourth or fifth mixture was combined with the additional remaining hot water with mixing to form a sixth mixture;

p) the sixth mixture was subjected to high speed shearing or blending for about 5 minutes, followed by a first homogenization step is conducted at a temperature range of approximately 120° F. to about 130° F. to form a seventh mixture which is cooled to a temperature of about 45° F. or less prior the next step;

q) the seventh mixture was subjected to a UHT pasteurization step to form an eighth mixture;

r) the eighth mixture was subjected to a second homogenization step at approximately 170° F. to about 180° F. to provide the foamable non-dairy composition of Example 1 which is cooled to approximately 45° F. or less prior to transfer to a sterile environment and packaged into suitable containers.

Milk protein concentrate (MPC) with lower calcium content (IdaPlus 1085 from Idaho Milk products) was used. It has more soluble caseins and better emulsification properties because of the lower calcium content. It also has better foaming properties than conventional Milk protein powders. The Calcium content of IdaPlus 1085 is 1750 mg/100 g of powder compared to 2150 mg/100 g for typical micellar casein powder.

The product from Example 2, when shaken and poured in hot coffee at the normal usage rates (60 ml creamer in 8 ounces of coffee), resulted in a foam height of 5 cm immediately after addition to the coffee. The foams are closely packed with velvety texture. Further, the foam is stable for >5 minutes over the surface of the hot coffee.

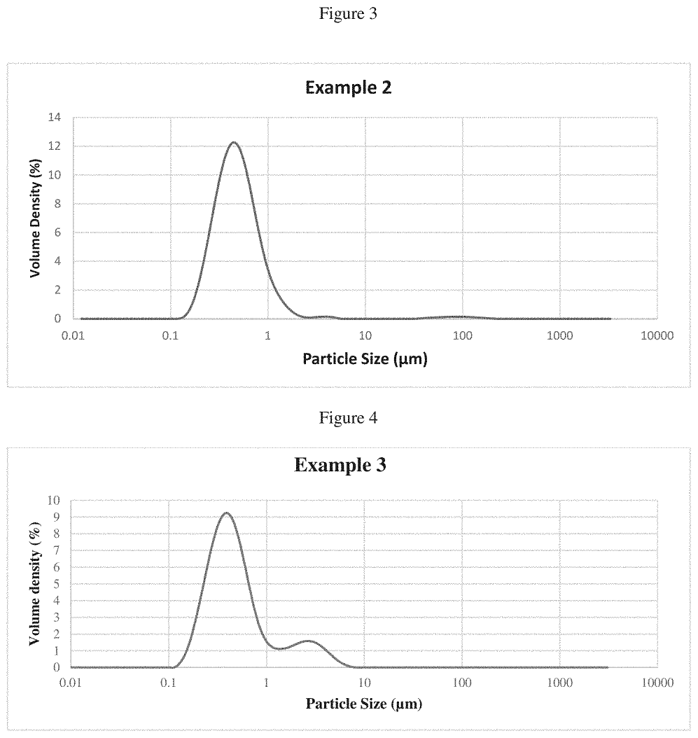

FIG. 3 provides the particle size for the formulation described above in Example 2.

Table 2 provides particle size characterization of Example 2.

TABLE 2

| | | | | | | Specific |
|---|---|---|---|---|---|---|
| Sample Name | D [3,2] | D [4,3] | Dx (10) | Dx (50) | Dx (90) | Surface Area |
| Example 2 | 0.426 | 1.59 | 0.254 | 0.464 | 0.935 | 14080 |

### Example 3

| Ingredient | % |
|---|---|
| Water | 57.296 |
| Trisodium Citrate | 0.120 |
| Sodium caseinate | 0.500 |
| Mono glycerides CARAVAN BFP | 0.070 |
| 75K | |
| Dipotassium Phosphate Liquid 50% | 0.800 |
| Salt Granulated Yellow Prussiate | 0.021 |
| of Soda MORTON TF | |
| SSL- Sodium Stearoyl Lactylate | 0.070 |
| (Emplex) | |
| sucrose | 31.590 |
| Carrageenan (Satiagel ACL 15 SB) | 0.085 |
| TC120790 NATURAL & | 0.210 |
| ARTIFICIAL FLAVOR FRENCH | |
| VANILLA TYPE | |
| Palm Oil | 8.300 |
| Myvatex Ice Lite blend of | 0.938 |
| polysorbate 80 and mono and | |
| diglycerides | |
| Total | 100.000 |

The process to prepare the composition of Example 3 was as follows. The water was heated to 165° F. and was at a minimum of 165° F. before transferring the water to a standard liquid blender (50 gallon capacity) with a shear impeller attached at the bottom. Agitation was initiated with the blender, then mono and diglycerides were added and mixed for 1 minute after addition was completed. A shear pump that was attached to the blender was started and recirculation was begun between the blender and a storage tank. To the recirculated liquid was added Myvatex Ice Lite and Trisodium Citrate, followed by sucrose. Agitation was turned on in the blender and Satiagel ACL 15 SB (Carrageenan or gellan gum depending on formula) was slowly dispersed and mixed for 2 minutes in the blender after all the gum was added to ensure ingredient dispersion.

The contents of blender were sent to the storage tank and the oil was added to the blender. Sodium caseinate follow by sodium stearoyl lactylate and then liquid polysorbate 80 were then added to the blender with the polysorbate 80 being heated to 120° F. to 140° F. prior to addition.

The salt and dipotassium phosphate liquid 50% were then added to the blender and the recirculation loop was resumed for 10 minutes through the blender and the storage tank. After 5 minutes, the contents of blender were transferred into pails and transferred, while hot, to a processor to homogenize at 2000/500 psi, in a 2-stage homogenization. Once the homogenization was completed, the solution was cooled and transferred for treatment with UHT/homogenization at 2000/600 psi, 2-stage homogenization. This step was conducted at a temperature range of approximately 120° F. to about 130° F. It was then subjected to a UHT pasteurization step, at a temperature of a least 298° F. for a few seconds, followed by a second homogenization step to provide a foamable non-dairy composition. The second homogenization step was conducted at a temperature range of approximately 170° F. to about 180° F. It was then cooled to a temperature of 45° F. or less prior to transfer to a sterile environment for packaging

The product was packed in 32 ounce bottles.

The product from Example 3 when shaken and poured in hot coffee at the normal usage rates (60 ml creamer in 8 ounces of coffee), resulted in a foam height of 5 cm immediately after addition to the coffee. The foams are closely packed with velvety texture. Further, the foam is stable for >5 minutes over the surface of the hot coffee.

FIG. 4 provides the particle size distribution (PSD) of Example 3.

### Example 4

| Ingredient | % |
|---|---|
| water | 57.919 |
| Trisodium Citrate | 0.120 |
| Dipotassium Phosphate Liquid 50% | 0.800 |
| sodium caseinate | 0.8000 |
| Salt | 0.021 |
| sucrose | 31.590 |
| Hyfoama RS from Kerry Foods | 0.300 |
| gellan gum HMB (CP Kelco) | 0.0300 |
| Lecithin Sunflower Liquid CARGILL | 0.1200 |
| TEXT Topcithin | |
| Palm Oil | 8.3000 |
| Flavoring (optional) | |
| Total | 100.000 |

Hyfoama RS is a rice based functional protein hydrolysate from Kerry Foods.

The process to prepare the composition of Example 4 was as follows. The water was heated to a minimum of 150° F. before transferring the water to a standard liquid blender (50 gallon capacity) with a shear impeller attached at the bottom. Agitation was initiated with the blender, then trisodium citrate were added and mixed for 1 minute after addition was completed. A shear pump that was attached to the blender was started and recirculation was begun between the blender and a storage tank. To the recirculated liquid sucrose was added. Agitation was turned on in the blender and gellan gum was slowly dispersed and mixed for 2 minutes in the blender after all the gum was added to ensure ingredient dispersion.

The contents of blender were sent to the storage tank and the oil along with lecithin was added to the blender. It was followed by Sodium caseinate to the blender

The salt, Hyfoama RS, dipotassium phosphate liquid 50% and flavorings (optional) were then added to the blender and the recirculation loop was resumed for 10 minutes through the blender and the storage tank. After 5 minutes, the contents of blender were transferred into pails and transferred, while hot, to a processor to homogenize at 2000/500 psi, in a 2-stage homogenization. Once the homogenization was completed, the solution was cooled and transferred for treatment with UHT/homogenization at 2000/600 psi, 2-stage homogenization. This step was conducted at a temperature range of approximately 120° F. to about 130° F. It was then subjected to a UHT pasteurization step, at a temperature of a least 298° F. for a few seconds, followed by a second homogenization step to provide a foamable non-dairy composition. The second homogenization step was conducted at a temperature range of approximately 170° F. to about 180° F. It was then cooled to a temperature of 45° F. or less prior to transfer to a sterile environment for packaging

The product was packed in 32 ounce bottles.

The product from Example 4 when shaken and poured in hot coffee at the normal usage rates (60 ml creamer in 8 ounces of coffee), did not obtain the foam layer on the top. No further testing is conducted as the samples failed to yield the required functionality. It was hypothesized that rice based protein hydrolysates interacted with highly reactive monomeric proteins (sodium caseinate) and formed a non-functional aggregate.

Ultrahigh temperature treatment (UHT). The heat treatment can be a direct heat treatment or an indirect heat treatment. UHT treatment is a process for preserving liquid beverages by exposing it to a brief, intense heating, normally to temperatures in the range of 135-145° C. for few seconds. This kills micro-organisms which would otherwise destroy the products. UHT treatment is a continuous process which takes place in a closed system. The product passes through heating and cooling stages. UHT processing can be used in conjunction with aseptic filling, to avoid re-contamination of with microbes. Two common methods of UHT treatment are used: (1) Indirect heating and cooling in heat exchangers, (2) Direct heating by steam injection or infusion of milk into steam and cooling by expansion under vacuum.

In certain aspects, the heat treatment iii) is under UHT and is carried out for less than 20 seconds and the mixture is heated to a final temperature of at least 140° C.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A composition comprising:
at least one of micellar casein or a caseinate or a mixture thereof;
one or more of dipotassium phosphate, tripotassium-dipotassium phosphate or trisodium-disodium phosphate;
a mixture of mono and diglycerides of edible fatty acids;
polysorbate 80 (Polyoxyethylene (20) sorbitan monooleate);
a gum;
a vegetable oil;
water;
optionally, a salt;
optionally, a citrate or a phosphate;
optionally, a stearoyl lactylate;
optionally, a sweetener; and
optionally, a flavoring, wherein the total amount of constituents equals 100 weight percent.

2. The composition according to claim 1, wherein the caseinate is sodium caseinate or calcium caseinate.

3. The composition according to claim 1, wherein the caseinate is present in an amount of about 0 percent to about 2 percent by weight of the total composition.

4. The composition according to claim 1, wherein the micellar casein is present in an amount of about 0 percent to about 2 percent by weight of the total composition.

5. The composition according to claim 1, wherein the one or more of dipotassium phosphate, tripotassium-dipotassium phosphate or trisodium-disodium phosphate is present in an amount of about 0.1 percent to about 2 percent by weight of the total composition.

6. The composition according to claim 1, wherein the mixture of mono and diglycerides of edible fatty acids are glyceryl monostearate and glyceryl distearate.

7. The composition according to claim 1, wherein the mixture of mono and diglycerides of edible fatty acids are present in an amount of about 0.001 percent to about 2 percent by weight of the total composition.

8. The composition according to claim 1, wherein the polyoxyethylene (20) sorbitan monooleate is present in an amount of about 0.001 percent to about 2 percent by weight of the total composition.

9. The composition according to claim 1, wherein the range of glyceryl monostearate to glycerol distearate is from about 60 percent by weight to about 80 percent by weight.

10. The composition according to claim 1, wherein the gum comprises carrageenan, gellan gum or a combination of gums.

11. The composition according to claim 1, wherein the vegetable oil comprises palm oil.

12. A composition comprising:
a milk protein concentrate (MPC);
one or more of dipotassium phosphate, tripotassium-dipotassium phosphate or trisodium-disodium phosphate;
alpha-cyclodextrin;
a vegetable oil;
optionally, a sweetener;
optionally, a citrate or a phosphate;
optionally, a flavoring agent;
optionally a salt; and
water to equal 100 percent by weight.

13. The composition according to claim 12, wherein the milk protein concentrate is present in an amount of about 0.1 to about 8 percent by weight of the total composition.

14. The composition according to claim 12, wherein the one or more of dipotassium phosphate, tripotassium-dipotassium phosphate or trisodium-disodium phosphate is present in an amount of about 0.001 to about 3 percent by weight of the total composition.

15. The composition according to claim 12, wherein the alpha-cyclodextrin is present in an amount of about 0.001 to about 3 percent by weight of the total composition.

16. The composition according to claim 12, wherein the vegetable oil comprises palm oil.

17. The composition according to claim 12, wherein the vegetable oil is present in an amount of about 2 to about 10 percent by weight of the total composition.
